(19) United States
(12) Patent Application Publication
(10) Pub. No.: US 2013/0139185 A1
(43) Pub. Date: May 30, 2013

(54) INTERCEPTING AND TRACING INTERFACE ROUTINE TRANSACTIONS

(71) Applicants: Paul Kendel Klissner, Eugene, OR (US); Michael S. Bender, Novato, CA (US)

(72) Inventors: Paul Kendel Klissner, Eugene, OR (US); Michael S. Bender, Novato, CA (US)

(73) Assignee: ORACLE INTERNATIONAL CORPORATION, REDWOOD SHORES, CA (US)

(21) Appl. No.: 13/307,183

(22) Filed: Nov. 30, 2011

(51) Int. Cl. G06F 9/46

(52) U.S. Cl. 719/328

(57) ABSTRACT

A tandem interposer-logger approach exploits the interface of a DLL routine that is exposed to client software modules that interoperate with each other through the DLL routine. The DLL routine may also be used to interact with other resources on a computer, including hardware resources. The interposer routine exposes the same interface as the DLL routine. Transparently to the client software, an interposer routine is substituted for the DLL routine such that the client software modules call the interposer routine instead of the DLL routine. When a client software module calls an interface function, the interposer's respective function is called, which collects tracing information to transmit to a daemon process referred to as a logger. The logger process stores the tracing information in a log. Tracing information can then be viewed by human users. The logger process is also used to manage operation of the interposer routine.

### FIELD OF THE INVENTION

The present application is related to utilities for debugging computer systems.

### BACKGROUND

Software is developed and provisioned using the modular approach. In the modular approach, software on a computer comprises software modules that are each configured to perform the detailed operations of a specific functionality. Any software module may need a multitude of functionality. Under the modular approach, software does not have to be written to perform every detailed operation of the needed functionality, but is instead configured to interoperate with prewritten software modules that do provide that functionality.

Software modules are categorized according to the type of function performed. For example, operating systems comprises software modules that provide common core functionality for interacting with computer hardware resources. User applications comprise software modules that help users perform certain task. Middleware comprises software modules that facilitate interaction between other software modules.

The modular approach allows software developers and providers to specialize in certain areas of functionality. Any given computer system can have multitudes of third party software modules from multitudes of third party providers.

Key to interoperability of software modules is interfaces. Interfaces allow software modules to interoperate effectively. An interface is a prescribed set of functions or routines (including class methods) provided by a software module that provides a particular functionality. Often the interface conforms to a specification developed and published by a standards body or software provider. The specification defines the functions or routines, including a name and arguments and argument data types, and behavior or protocol followed by the functions and routines.

Often, interfaces are implemented using dynamically linked library routines referred to herein as DLL routines. Software modules that interface with DLL routines are written to invoke the functions of the interface that the DLL routine exposes. During runtime, the software modules are dynamically linked to the DLL routines the software modules reference.

### DEBUGGING SOFTWARE MODULES AND EXAMPLE

The modular approach greatly reduces the cost and time of developing software and increases quality and robustness of functionality. Further, a software provider can incorporate in its software product “third party” software provided by other vendors, avoiding the need and cost to develop equivalent software in-house, greatly reducing costs.

However, the modular approach adds layers of difficulty to the task of debugging and testing software, both during development and during deployment in the field. The difficulty is further compounded by the dependency upon third party software modules and its providers. Some third party software modules are from established providers that provide a high quality and robust debugging capability, and even effective technical support, while other software vendors do not provide the same level of quality, debugging capability, and technical support.

To provide a concrete illustration to facilitate exposition of debugging difficulties, debugging difficulties are illustrated using THIN DESKTOP CLIENT NETWORK 101 depicted in FIG. 1. Though these debugging difficulties are illustrated in the specific context of THIN DESKTOP CLIENT NETWORK 101, it should be understood that the aforementioned debugging difficulties pervade many kinds of computer environments.

Referring to FIG. 1, THIN DESKTOP CLIENT NETWORK 101 includes THIN CLIENTS 102 through which a user runs desktop applications remotely on a BACKEND DESKTOP APP COMPUTER 110. A thin client is a computer that interfaces with a user and that relies on another computer to provide core computer resources, allowing a thin client to be manufactured relatively cheaply. THIN CLIENTS 102 are each implemented to operate as remote desktops, having the set of hardware needed to run as a remote desktop under control of another controlling computer via a network connection. A remote desktop is an allocation of a computer system, including CPU time, memory, for running remote desktop software, the execution of which by the computer system causes the computer system to operate its peripherals as peripherals of another computer, under control of the other computer via a network connection. The peripherals include peripherals such as a serial bus device, video display, sound devices, and keyboard.

Each of THIN CLIENTS 102 exploits the computing power of a BACKEND DESKTOP APP COMPUTER 110 to run desktop applications on behalf of users, using a remote desktop hosted by THIN CLIENTS 102. Desktop applications are applications that interface with human users via graphical use interfaces (e.g. browsers, email clients).

In contrast to any of THIN CLIENTS 102, BACKEND DESKTOP APP COMPUTER 110 has vastly greater computing capacity. BACKEND DESKTOP APP COMPUTER 110 can run multiple user sessions, each supporting and running a desktop application using a remote desktop on a thin client 102. Each session running on BACKEND DESKTOP APP COMPUTER 110 communicates with and controls a thin client 102 via a remote desktop utility that follows a standard remote desktop specification, such as the Remote Desktop Protocol (RDP) and Applicant Link Protocol (ALP).

In this illustration, THIN CLIENTS 102 and BACKEND DESKTOP APP COMPUTER 110 are provided by a vendor, and run under a UNIX or LINUX platform. Customers of the vendor desire to run desktop applications that run under a different platform than that of either THIN CLIENTS 102 and BACKEND DESKTOP APP COMPUTER 110. For example, customers may wish to run popular desktop applications that run on a Windows™ platform using THIN CLIENTS 102 as remote desktops.

To run a desktop application on AUXILIARY DESKTOP APP COMPUTER 120 using a thin client 102 as a remote desktop, thin client 102 starts a remote desktop session on BACKEND DESKTOP APP COMPUTER 110, which in turn starts a respective remote desktop session on AUXILIARY DESKTOP APP COMPUTER 120. The desktop application runs in a session on AUXILIARY DESKTOP APP COMPUTER 120, interacting with the respective desktop session on BACKEND DESKTOP APP COMPUTER 110 according to a remote desktop protocol. The session on BACKEND DESKTOP APP COMPUTER 110 interacts with the thin client 102 using a remote desktop protocol. To provide this capability, THIN DESKTOP CLIENT NETWORK 101 is configured to run a remote desktop utility native to the platform of AUXILIARY DESKTOP APP COMPUTER 120. When AUXILIARY DESKTOP APP COMPUTER 120 runs its native remote desktop utility, the remote desktop utility interacts with BACKEND DESKTOP APP COMPUTER 110 using a REMOTE DESKTOP UTILITY 111 native to the platform of BACKEND DESKTOP APP COMPUTER 110, in the same way AUXILIARY DESKTOP APP COMPUTER 120 interacts with a remote desktop client via a direct network connection.

### Multiplicity of Software/Hardware Layers

In THIN DESKTOP CLIENT NETWORK 101, running a peripheral within a remote desktop transcends many layers of software and hardware. A bug might occur in any one of these layers. To debug the bug, a software developer may not only have to debug its own software modules, but also debug third party software modules, which often requires coordinating with technical support of the third software provider.

For example, THIN CLIENTS 102 are configured to use a smart card to provide certain smart card functionality that includes authenticating users and transferring sessions of users between THIN CLIENTS 102. A smart card is a card on which a CPU processor and persistent memory is embedded. Software instructions may be downloaded to the memory and executed by the CPU, which may manipulate the data in memory pursuant to execution of the software. A smart card may also have authentication hardware that may be used to authenticate a user with a computer to which the smart card is plugged-in.

A desktop application, using the remote desktop of a thin client 102 for a graphical user interface, may interact with a smart card plugged into the thin client 102. Such interaction occurs through multiple layers of software and hardware, including hardware on the smart card, a USB device, USB driver and operating system on the thin client 102, a remote desktop utility on a thin client 102, network layer between the thin client 102 and BACKEND DESKTOP APP COMPUTER 110, remote desktop utility and operating system on BACKEND DESKTOP APP COMPUTER 110, a network layer between BACKEND DESKTOP APP COMPUTER 110 and AUXILIARY DESKTOP APP COMPUTER 120, REMOTE DESKTOP UTILITY 121, SMART CARD UTILITY 122, and SMART CARD MIDDLEWARE 123.

SMART CARD UTILITY 122 comprises a dynamically linked library (“DLL”) routine that exposes an interface for interacting with a smart card. SMART CARD UTILITY 122 itself interfaces with SMART CARD MIDDLEWARES 123. SMART CARD MIDDLEWARES 123 comprises multiple middlewares, each middleware being provided by a third party vendor to interact with a particular smart card product.

In order for a client process on a computer to interact with various smart card products, the client invokes an interface function of a SMART CARD UTILITY 122. When a client process interacts with a smart card, including one connected to a remote desktop, the client process calls the interface functions of SMART CARD UTILITY 122. To interact with the smart card product, SMART CARD UTILITY 122 invokes the smart card middleware provided for that particular smart card product. Such interaction includes calling interface functions of the smart card middleware and the smart card middleware calling interface functions of the SMART CARD UTILITY 122.

A provider of a THIN DESKTOP CLIENT NETWORK 101 needs to ensure that the smart card functionality works with many smart card products. When debugging the smart card functionality for a particular smart card product, a developer faces multiple layers that may each be the source of a bug, including layers of third party software. Among the third party software is SMART CARD UTILITY 122 and the particular middleware of SMART CARD MIDDLE WARES 123 provided for each of the many smart card product.

Thus debugging smart card functionality is encumbered by difficulties attendant to debugging third party software mentioned previously. These difficulties are further exasperated by the many instances of SMART CARD MIDDLEWARES 123, which are provided by many third party software providers, and which may have debugging capabilities and technical support that can vary widely in quality.

### BRIEF DESCRIPTION OF THE DRAWINGS

In the drawings:

FIG. 1 is diagram depicting a thin desktop client network comprising thin desktop clients that interact with a desktop application several layers of computers removed from the desktop according to an embodiment of the present invention.

FIG. 2 depicts elements of the tandem interposer-logger approach for generating tracing values generated for a DDL routine according to an embodiment of the present invention.

FIG. 3 depicts an import library declaration according to an embodiment of the present invention.

FIG. 4 is a flowchart depicting operations performed by an interposer implementation according to an embodiment of the present invention.

FIG. 5 depicts a signature declaration for an interface function implemented within an interposer routine and key-value pairs generated by the interposer implementation according to an embodiment of the present invention.

FIG. 6 is a diagram of a computer system that may be used in an implementation of an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Described herein is an approach for facilitating the debugging of third party software modules. The approach is referred to as the tandem interposer-logger approach. Tandem interposer-logger approach exploits the interface of a DLL routine that is exposed to client software modules that interoperate with each other through the DLL routine. The DLL routine may also be used to interact with other resources on a computer, including hardware resources. Transparently to the client software, an interposer routine is substituted for the DLL routine such that the client software modules call the interposer routine instead of the DLL routine. The DLL routine of which the interposer is a substitute is referred to herein as a base DLL routine with respect to the interposer routine. The interposer routine exposes the same interface as the DLL routine.

When a client software module calls an interface function, the interposer's respective function is called, which collects tracing information to transmit to a daemon process referred to as a logger. Among other responsibilities, the logger process stores the tracing information in a log (e.g. log files). Tracing information can then be viewed by human users. The logger process is also used to manage operation of the interposer routine.

Client software modules of a DLL routine may be executed by many client processes, which pursuant execution of client software modules, results in execution of the interposer routine and transmission of tracing information to the same logger process. Thus the logger process collects tracing information from multiple client processes and may be used to control tracing activity of those client processes. In this way, multiple client processes, executing the interposer, work in tandem with a logger process, to generate and store tracing information.

The base DLL routine may be a utility through which the software of a software developer may interoperate with many third party software and/or hardware products. The interposer allows interactions between software developer's software and third party software and/or hardware to be monitored and traced to provide useful debugging information to all involved parties.

As the term is used herein, a process is an allocation of computing resources, including processor time and memory, for executing particular software on a computing device. Furthermore, as is a practice of those skilled in the art, software modules are described herein as performing actions and operations as a convenient way of expressing that a process performs those actions and operations pursuant execution of the software modules. For example, a client software module calling an interface function is a convenient way of expressing that a client process executing the software module calls the interface function. An interface function of an interposer routine generating tracing information and transmitting the tracing information to a logger is a convenient way of expressing that a client process, pursuant execution of the interposer routine, generates the tracing information and transmits the information to a logger.

### Illustrative Implementation

To use a concrete example to facilitate understanding of the tandem interposer-logger approach, the approach is described herein within the context of THIN DESKTOP CLIENT NETWORK 101. However, an embodiment of the present invention is not limited to this context.

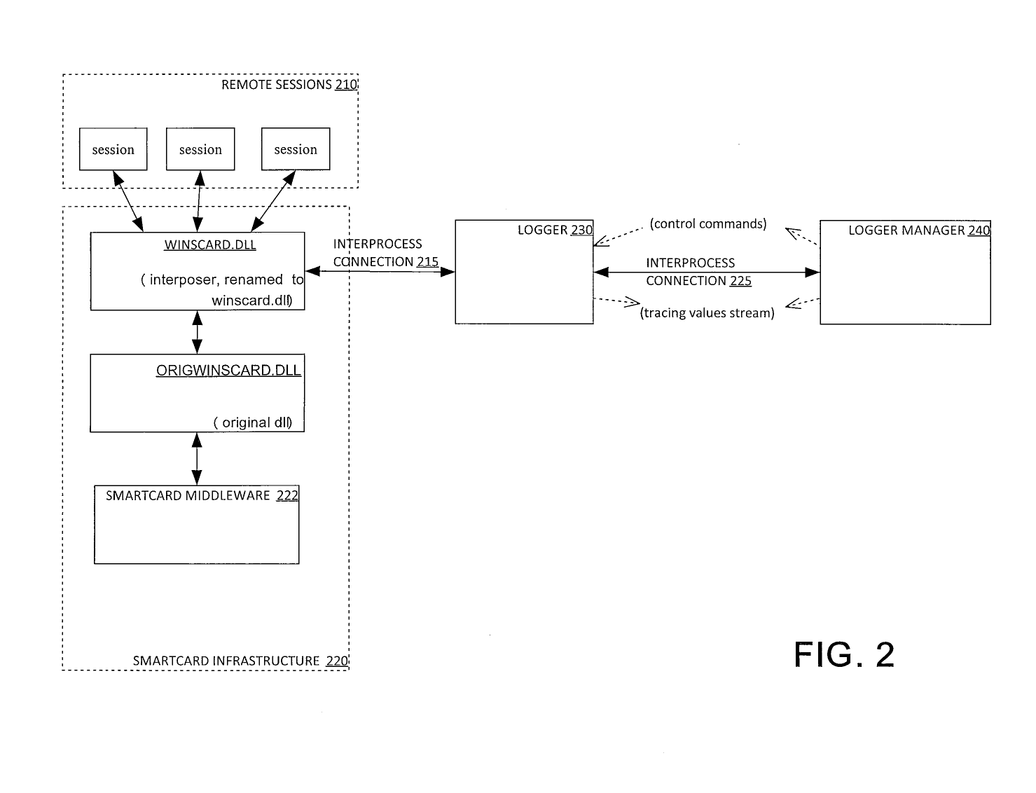

FIG. 2 is a diagram depicting aspects of an implementation of the tandem interposer-logger approach on THIN DESKTOP CLIENT NETWORK 101 according to an embodiment of the present invention.

Referring to FIG. 2, it depicts interposer SMART CARD INFRASTRUCTURE 220 hosted on a AUXILIARY DESKTOP APP COMPUTER 120. SMART CARD INFRASTRUCTURE 220 includes software and hardware needed to interact with smart cards. In an embodiment, smart card infrastructure includes routine winscard.dll, a smartcard DLL utility, such as SMART CARD UTILITY 122. The routine winscard.dll is a dynamically linked routine that implements an interface that conforms to the Personal Computer/Smart Card (“PC/SC”) specification for smart card interfaces, herein referred to as the WinSCard interface. The interface is exposed for dynamic linking using the dynamic linking capabilities native to the Windows operating system.

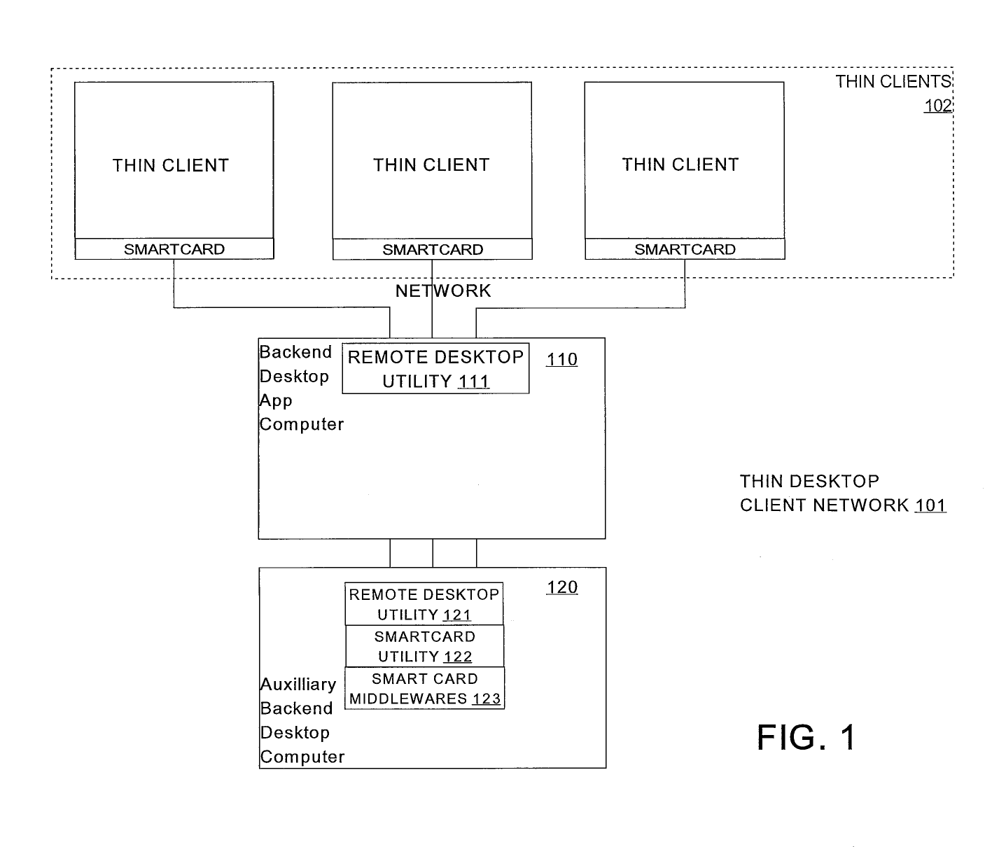

Winscard.dll itself is not depicted in FIG. 1. Rather, an interposer given the same name is shown. Interposer WINSCARD.DLL is a dynamically linked routine given the name “winscard.dll”. The winscard.dll routine native to Windows operating system is renamed to WINSCARDORIG.DLL (see FIG. 2).

According to an embodiment, interposer WINSCARD.DLL has an implementation for some but not all interface functions of the WinSCard interface. An interface function of the WinSCard interface that is implemented in interposer WINSCARD.DLL is referred to herein as interposer-implemented. As shall be explained in greater detail, each interposer-implemented function of interposer WINSCARD.DLL calls out to a respective WinSCard interface function of WINDSCARDORIG.DLL, such function being referred to herein as a base function. In addition, each implemented interface function performs tracing operations. For example, the WinSCard interface includes a function SCardConnectA. Interposer WINSCARD.DLL implements the function SCardConnectA. The implementation calls out to SCardConnectA of WINDSCARDORIG.DLL. In addition, SCardConnectA of interposer WINSCARD.DLL performs operations needed for supporting tracing, as shall be described in greater detail.

SMART CARD MIDDLEWARE 222 comprises middleware that may be provided by many third parties to interact with specific smart cards. A particular smart card middleware is dynamically linked to winscard.dll when, for example, a smart card for which the particular smart card middleware was developed is plugged into a smart card reader, either a locally smart card reader or one attached to a thin client 102. On THIN DESKTOP CLIENT NETWORK 101, the smart card middleware is dynamically linked to interposer WINSCARD.DLL instead of the native winscard.dll routine.

REMOTE SESSIONS 210 are each executing a desktop application that interfaces with SMART CARD INFRASTRUCTURE 220 and REMOTE DESKTOP UTILITY 121 to interact with a respective remote desktop on a thin client 102. To interface with a smart card plugged into a thin client 102, a remote session 210 invokes interposer WINSCARD.DLL, thereby executing the SMART CARD INFRASTRUCTURE 220, including SMART CARD MIDDLEWARE 222.

There may be other client processes other than those of REMOTE SESSIONS 210 invoking interposer WINSCARD.DLL.

LOGGER 230 is a daemon process, separate from REMOTE SESSIONS 210, that receives and records a set of tracing values generated by interposer WINSCARD.DLL. LOGGER 230 runs local to REMOTE SESSIONS 210. The stream of tracing values are transmitted via INTER-PROCESS CONNECTION 215.

Preferably, INTER-PROCESS CONNECTION 215 is a type of connection that is efficient for communication between local processes on the same computer, such as a named pipe connection. An embodiment of the present invention, however, is not limited to any form of an inter-process connection.

LOGGER 230 stores tracing values in logs persistently stored in local storage or remote storage. In addition to receiving and recording a stream of tracing values, LOGGER 230 controls operation of WINSCARD.DLL., and interacts with a user via DIAGNOSTIC FACILITY UTILITY 240.

DIAGNOSTIC FACILITY UTILITY 240 is a user application. It is connected to LOGGER 230 via an INTER-PROCESS CONNECTION 225. It includes a user interface through which a user may control the operation of interposer WINSCARD.DLL and LOGGER 230. DIAGNOSTIC FACILITY UTILITY 240 also includes a viewing capability that allows a user to view tracing values that have been rendered for display by a human user. The utility also includes a reporting capability that summarizes and aggregates tracing values generated.

DIAGNOSTIC FACILITY UTILITY 240 may be hosted locally with LOGGER 230 or run remotely on another computer system. For example, DIAGNOSTIC FACILITY UTILITY 240 may run on BACKEND DESKTOP APP COMPUTER 110 or on AUXILIARY DESKTOP APP COMPUTER 120. In an embodiment, LOGGER 230 transmits tracing values via INTER-PROCESS CONNECTION 225 to DIAGNOSTIC FACILITY UTILITY 240, which may store the tracing values in a log for later retrieval and processing.

### Implemented Interface Functions

As mentioned previously, in an embodiment some WinSCard interface functions are interposer-implemented while others are not. Nevertheless, clients of the SMART CARD INFRASTRUCTURE 220 need to be linked to a WinSCard interface function. According an embodiment, configuration of interposer WINSCARD.DLL exposes WinSCard interface functions such that, during dynamic linking between a client program and interposer WINSCARD.DLL, the client program is linked to interposer-implemented functions in interposer WINSCARD.DLL and linked to WinSCard interface functions in WINSCARDORIG.DLL that are not interposer-implemented. To dynamically link in this way, according to an embodiment, an import library declaration is used. Dynamic linking mechanisms of many operating systems incorporate import library declarations to associate with a DLL routine. The import library declarations list functions of a DLL routine that are exposed, that is, the functions that can be referenced by and dynamically linked to other routines. The exposed functions can be mapped to a function of the DLL routine associated with the import library or to a function of another DLL routine.

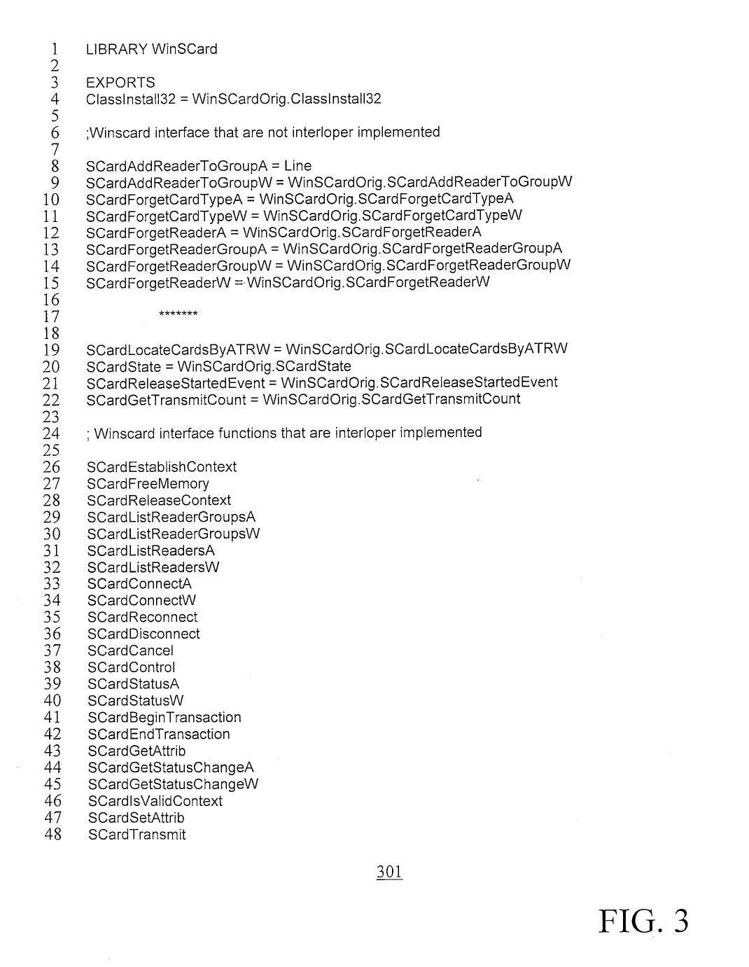

FIG. 3 shows a portion of import library declaration 301 that exposes WinSCard interface functions for interposer WINSCARD.DLL, according to an embodiment of the present invention. Referring to FIG. 3, import library declaration 301 lists exposed functions of interposer WINSCARD.DLL. Lines 8-22 lists WinSCard interface functions that are not interposer-implemented, mapping each to a WinSCard interface function in WINSCARDORIG.DLL. For example, line 8 lists and maps WinSCard interface function SCardAddReaderToGroupA to SCardAddReaderToGroupA in WinSCardOrig.

Lines 26-48 list the exposed WinSCard interface functions that are interposer-implemented in interposer WINSCARD.DLL. For example, line 26 lists SCardEstablishContext and line 27 lists SCardEstablishContext.

### Implementation Overview of Interposer-Implemented Functions

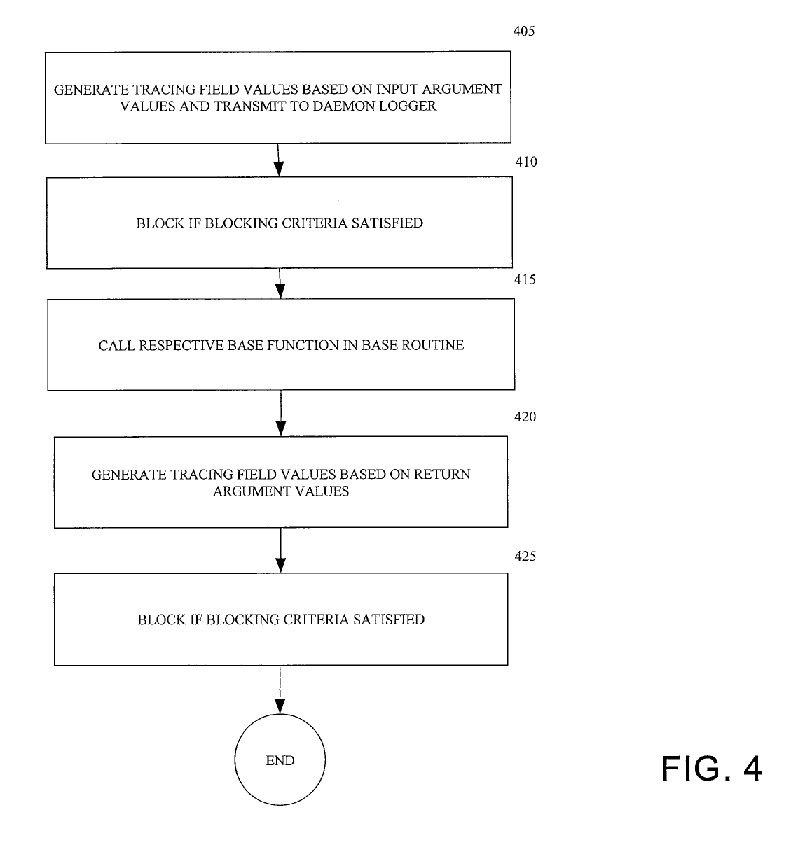

As mentioned before, each interposer-implemented function of interposer WINSCARD.DLL generates tracing values and calls out to a respective WinSCard interface function of WINDSCARDORIG.DLL. FIG. 4 shows the operations performed by an interposer-implemented function when invoked by a client, according to an embodiment of the present invention.

Referring to FIG. 4, at operation 405 an IN-set of tracing field values are generated, based on input argument values, and transmitted to LOGGER 230 via the INTER-PROCESS CONNECTION 215. The particular set of tracing field values generated depends on the particular function being invoked. The field values are generated from input function arguments values passed in by a client process. Tracing field values may also be generated based on the execution context of the client process. For example, a tracing field may be the session id of the remote session of the client process invoking the interposer-implemented function.

At operation 410, execution is blocked if blocking is enabled. Blocking execution allows developers to attach debugging utilities to the client process to examine the client process blocked. An example of a blocking condition is that blocking has been requested for a client process having a particular session id or process id. Blocking and blocking enablement are described in greater detail later.

At operation 415, the respective base function in the base DLL routine is called. For example, when a client process calls SCardAddReaderToGroupA of interposer WINSCARD.DLL, SCardAddReaderToGroupA in WinSCardOrigin is called.

After the call to the respective base function returns, at operation 420 an OUT-set of tracing field values are generated based on return argument values and are transmitted to LOGGER 230 via the named pipe connection. Again, tracing field values may also be generated based on execution context.

At operation 420, execution is blocked if blocking is enabled, and then execution of the procedure ends.

According to an embodiment, the tracing operations performed by an interposer-implemented function are minimized to reduce the possibility of errors in client processes. Preferably, operations are limited to generating sets of tracing values and checking for blocking enablement while other operations for recording the tracing values, tracing management, etc. are performed by LOGGER 230.

The particular set of operations performed in FIG. 4 are illustrative and not limiting. In an embodiment, an interposer-implemented function may only block before or only after calling the base function, or may not block at all. Further, only an IN-set or OUT-set of tracing fields values may be generated. The tracing field values may not include some of those described herein and may include others not described.

### Generating and Storing Tracing Field Values

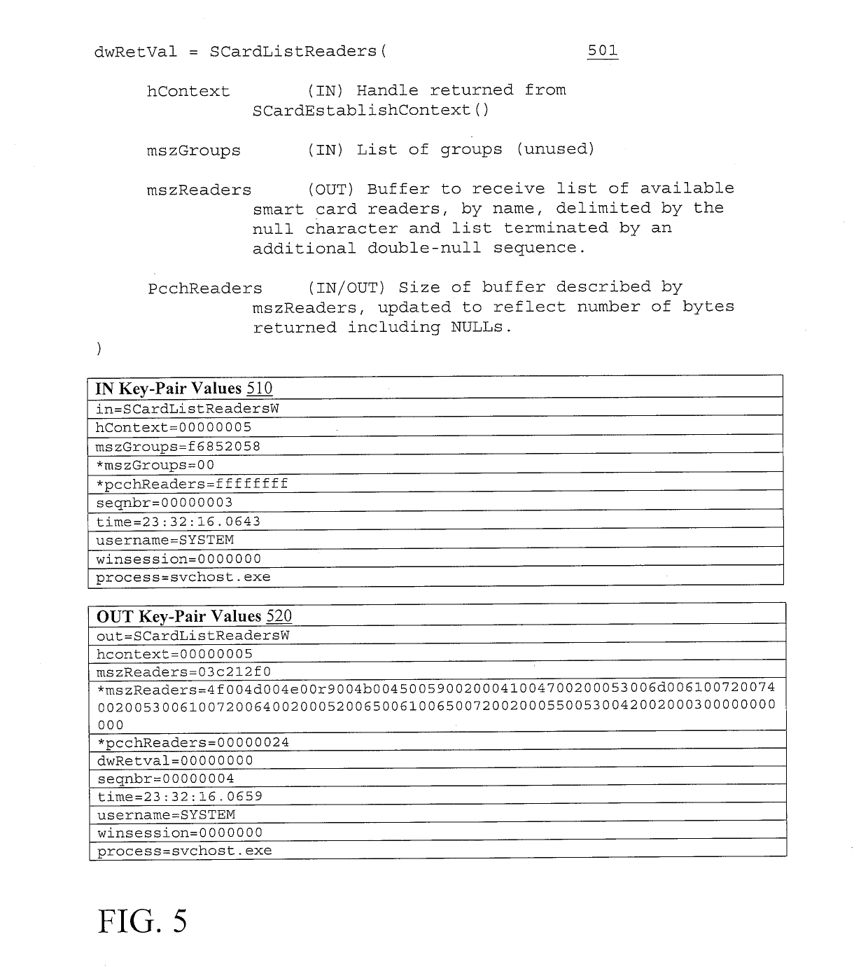

According to an embodiment, tracing field values generated by an interposer-implementation are key-value pairs. Furthermore, the values from which key-value pairs are generated may be decoded and transformed into field values that are more meaningful to computers and/or humans. Example sets of key-value pairs that can be generated are illustrated by FIG. 5.

Referring to FIG. 5, it shows the signature declaration 501 for SCardListReaders, including a list of arguments and a description of the semantics of the arguments. IN KEY-VALUE PAIRS 510 are the IN-set key-value pairs generated for SCardListReaders and OUT KEY-VALUE PAIRS 520 are the OUT-set key-value pairs generated.

Referring to IN KEY-VALUE PAIRS 510, key-value pair in=SCardListReaders designates that IN KEY-VALUE PAIRS 510 is an IN-set generated for SCardListReaders. The Win the value SCardListReadersW specifies UNICODE 16-bit characters are passed in.

The value in key-value pair mszGroups=f6 852 058 is a pointer passed in for argument mszGroups. The respective deferenced value of the pointer is specified in the key-value pair *mszGroups=00. This key-value pair is an example of decoding and/or translating of tracing values to more meaningful values.

Some key-value pairs in IN KEY-VALUE PAIRS 510 convey useful information about the execution context of the invocation in which the IN-set is generated. Key-value pair time=23:32:16.0643 specifies the time of the call, winsession=0000000 specifies the session id of the client process, username=SYSTEM specifies the name of the user associated with the session.

Referring to OUT KEY-VALUE PAIRS 520, key-value pair out=SCardListReadersW designates that OUT KEY-VALUE PAIRS 520 is an OUT-set generated by a call to SCardListReaders. For key-value pair mszReaders=03c212f0, the value is a pointer value for the argument mszGroups, a pointer to a buffer that lists available smart card readers. The value of key-value pair *mszReaders=5300 . . . 00000 specifies the contents in the buffer. The value of key-value pair *pcchReaders=00000024 specifies the size of the buffer.

The key-value pair *mszReaders=5300 . . . 00000 may be further decoded into ASCII as “Sun Ray DTU Internal Reader 00 00” terminated with three NULL-byte characters, which, as specified by pcchReaders is 0x24 (30 decimal) bytes in length. Decoding of key-value pair *mszReaders=5300 . . . 00000 can occur at various stages of processing tracing values. The decoding may be performed by the client process executing function SCardListReaders. However, to minimize operations performed by the function, LOGGER 230 may decode the key-value pair before storing the key-value pair in a log. Alternatively, the key-value pair may be stored without decoding and later decoded by DIAGNOSTIC FACILITY UTILITY 240 when displaying OUT KEY-VALUE PAIRS 520 to a user.

Key-value pair dwRetval=00000000 specifies the return value of function SCardListReaders.

When LOGGER 230 receives a set of key-value pairs, the set is stored in a log as a log entry. The log may be a log file stored locally or remotely relative to LOGGER 230.

Key-value pairs are one example of structuring tracing values into fields. In another example, tracing fields may be stored as delimited fields in a log. The present invention is not limited to any particular way of structuring log entries as fields.

### Blocking Execution

According to an embodiment, to enable blocking a user may submit a command to “halt” to DIAGNOSTIC FACILITY UTILITY 240. When the halt command is received, the DIAGNOSTIC FACILITY UTILITY 240 conveys, via the LOGGER 230, to interposer WINSCARD.DLL, that the blocking is enabled and that the interposer WINSCARD.DLL should block. For each client process of WINSCARD.DLL, a blocking status is checked upon loading and then re-checked each time a message is delivered by LOGGER 230 to the client process.

When the blocking status specifies to block, a client process executing interposer WINSCARD.DLL is notified that it is to halt, and sets a global flag that is unique to the memory space of the client process, specifying that blocking is enabled. Since each client process of interposer WINSCARD.DLL checks the blocking status, any client process of interposer WINSCARD.DLL is notified that blocking is enabled. In this way, blocking enablement of all client processes is set (or cleared) by a singled command via the DIAGNOSTIC FACILITY UTILITY 240.

In an interposer-implemented function, for operation 410 and 420 (see FIG. 4), a check is made to determine if the global flag is set. If the global flag is set, the interposer-implemented function issues an operating system specific wait (blocking) function call. In Windows, that function is WaitForSingleObject( ). This wait function causes the thread that invokes the function to block in CPU-efficient mode until alerted to wake up via a corresponding operating system specific notification function. A token is used to uniquely identify what condition is being waited for, and that token is used to indicate which waiting thread(s) should be awaken by the notification. In Windows, the SetEvent( ) function is the notification function that wakes up waiters blocking in WaitForSingleObject( ). When any thread blocking in WaitForSingleObject( ) is released by SetEvent( ) the global flag is re-checked. If the global flag is clear, processing continues. Otherwise, if the blocking flag is set, WaitForSingleObject( ) is called again. In this way, a halt command issued to the logging manager can block all client processes' execution of interposed-implemented functions.

Embodiments of the invention have been described with reference to numerous specific details that may vary from implementation to implementation. The tandem interposer-logger approach has been illustrated using an interposer that intercepts calls to a DLL routine that provides an interface to the smartcard infrastructure of a computer system, but the present invention is not so limited. An embodiment of the present invention may be used for any DLL routine within the input path of any client software and other layer of software and/or hardware. For example, an embodiment may be used within the USB framework of Windows, which uses WinUSB.dll. Another example is the graphics framework in Windows, which uses Windows.Graphics.dll. These are just few examples among many others.

The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

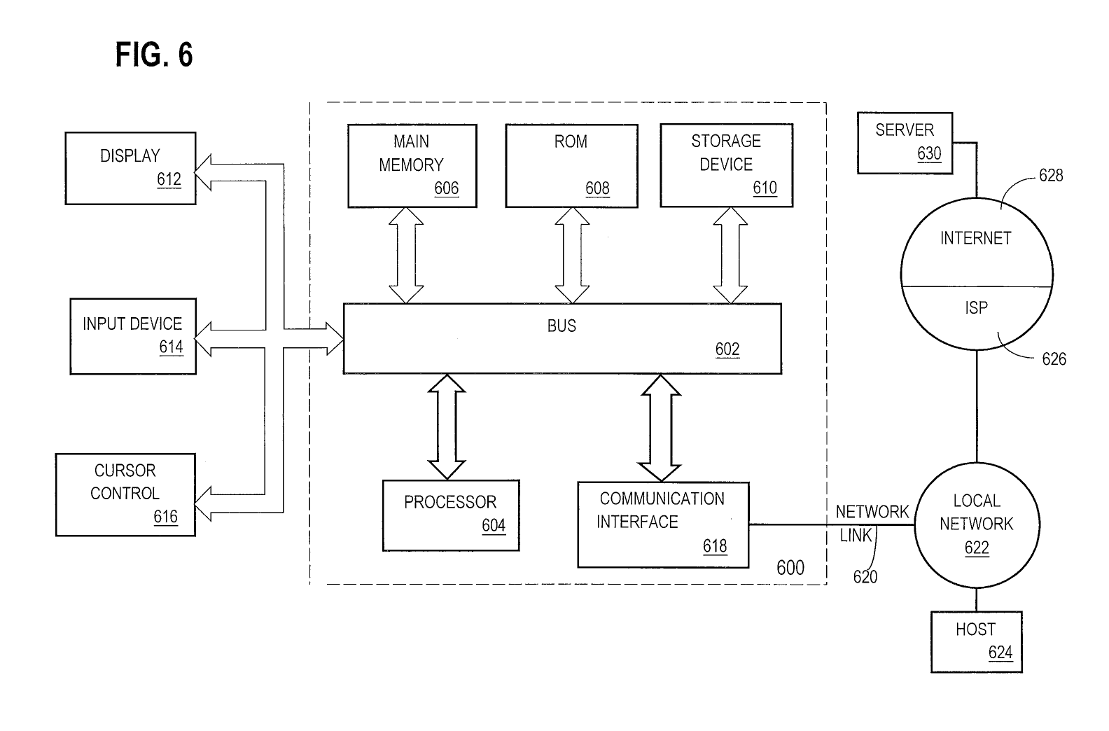

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

What is claimed is:

1. A computer implemented method, comprising steps of:
on a computer system a client process executing a certain function of an interposer routine pursuant execution of a client software module;
wherein said certain function belongs to an interface exposed by another DLL routine;
wherein said interposer routine implements at least some functions of said interface, including said certain function, the implementation of said certain function being configured to call a respective interface function of said DLL routine;
wherein said client software module is configured to interact with said DLL routine by invoking the interface functions;
wherein executing said certain function includes:
generating tracing values,
transmitting said tracing values to a logger process via an interprocess connection,
calling the respective function of said DLL routine; and
a logger process running on said computer system receiving said tracing values; and
once received by said logger process, storing said sets of tracing values.

2. The method of claim 1,
wherein executing said certain function includes:
determining one or more blocking criteria is satisfied;
blocking execution of said certain function.

3. The method of claim 1, wherein the one or more blocking criteria is based on user input received by said logger process.

4. The method of claim 1, wherein generating tracing values includes generating a set of tracing field values for a set of tracing fields.

5. The method of claim 4, wherein generating a set of tracing field values for a set of tracing fields includes decoding a tracing value of said tracing values to generate a tracing field value for a tracing field.

6. The method of claim 4, generating a set of tracing field values for a set of tracing fields includes generating a set of tracing key-pair values.

7. The method of claim 1, wherein the logger process is connected via network to a logger manager running on another computer system, wherein the steps further include said logger receiving commands to control operation of said logger.

8. A computer implemented method, comprising steps of:
while a plurality of client processes are running on a computer system, each client process of said plurality of client processes invoking and executing a certain function of an interposer routine pursuant execution of a respective client software module;
wherein said certain function belongs to an interface implemented by another DLL routine;
wherein said interposer routine implements at least some functions of said interface, including said certain function, the implementation of said certain function being configured to call a respective interface function of said DLL routine;
wherein said respective client software module is configured to interact with said DLL routine by invoking the interface functions; and
wherein executing said certain function includes each client process of said plurality of processes:
generating one or more sets of tracing values,
transmitting said one or more sets of tracing values to a logger process via an inter-process connection, and
calling the respective function of said DLL routine;
a logger process running on said computer system receiving the sets of tracing values generated by said plurality of client processes; and
once received by said logger process, storing said sets of tracing values.

9. The method of claim 8, wherein generating one or more sets of tracing values includes generating one or more sets of tracing field values for a set of tracing fields.

10. The method of claim 1, wherein the logger process is connected via network to a logger manager running on another computer system, wherein the steps further include said logger manager receiving commands to control operation said plurality of clients execution of said certain function.

11. A non-transitory computer-readable storage medium storing one or more sequences of instructions for document-class-based cache management of documents, wherein execution of the one or more sequences of instructions by one or more processors causes the one or more processors to perform the steps of:
on a computer system a client process executing a certain function of an interposer routine pursuant execution of a client software module;
wherein said certain function belongs to an interface exposed by another DLL routine;
wherein said interposer routine implements at least some functions of said interface, including said certain function, the implementation of said certain function being configured to call a respective interface function of said DLL routine;
wherein said client software module is configured to interact with said DLL routine by invoking the interface functions;
wherein executing said certain function includes:
generating tracing values,
transmitting said tracing values to a logger process via an interprocess connection,
calling the respective function of said DLL routine; and
a logger process running on said computer system receiving said tracing values; and
once received by said logger process, storing said sets of tracing values.

12. The computer-readable storage medium of claim 11,
wherein executing said certain function includes:
determining one or more blocking criteria is satisfied;
blocking execution of said certain function.

13. The computer-readable storage medium of claim 11, wherein the one or more blocking criteria is based on user input received by said logger process.

14. The computer-readable storage medium of claim 11, wherein generating tracing values includes generating a set of tracing field values for a set of tracing fields.

15. The computer-readable storage medium of claim 14, wherein generating a set of tracing field values for a set of tracing fields includes decoding a tracing value of said tracing values to generate a tracing field value for a tracing field.

16. The computer-readable storage medium of claim 14, generating a set of tracing field values for a set of tracing fields includes generating a set of tracing key-pair values.

17. The computer-readable storage medium of claim 11, wherein the logger process is connected via a network to a logger manager running on another computer system, wherein the steps further include said logger receiving commands to control operation of said logger.

18. A non-transitory computer-readable storage medium storing one or more sequences of instructions for document-class-based cache management of documents, wherein execution of the one or more sequences of instructions by one or more processors causes the one or more processors to perform the steps of:
while a plurality of client processes are running on a computer system, each client process of said plurality of client processes invoking and executing a certain function of an interposer routine pursuant execution of a respective client software module;
wherein said certain function belongs to an interface implemented by another DLL routine;
wherein said interposer routine implements at least some functions of said interface, including said certain function, the implementation of said certain function being configured to call a respective interface function of said DLL routine;
wherein said respective client software module is configured to interact with said DLL routine by invoking the interface functions; and
wherein executing said certain function includes each client process of said plurality of processes:
generating one or more sets of tracing values,
transmitting said one or more sets of tracing values to a logger process via an inter-process connection, and
calling the respective function of said DLL routine;
a logger process running on said computer system receiving the sets of tracing values generated by said plurality of client processes; and
once received by said logger process, storing said sets of tracing values.

19. The computer-readable storage medium of claim 18, wherein generating one or more sets of tracing values includes generating one or more sets of tracing field values for a set of tracing fields.

20. The computer-readable storage medium of claim 11, wherein the logger process is connected via network to a logger manager running on another computer system, wherein the steps further include said logger manager receiving commands to control operation said plurality of clients execution of said certain function.
